(19) United States
(12) Patent Application Publication
(10) Pub. No.: US 2020/0264921 A1
(43) Pub. Date: Aug. 20, 2020

(54) CRYPTO ENGINE AND SCHEDULING METHOD FOR VECTOR UNIT

(71) Applicant: Nanjing Iluvatar CoreX Technology Co., Ltd. (DBA "Iluvatar CoreX Inc. Nanjing"), Nanjing (CN)

(72) Inventors: Pei Luo, San Jose, CA (US); Pingping Shao, San Jose, CA (US); Cheng Li, San Jose, CA (US)

(73) Assignee: Nanjing Iluvatar CoreX Technology Co., Ltd. (DBA "Iluvatar CoreX Inc. Nanjing"), Nanjing (CN)

(21) Appl. No.: 16/281,056

(22) Filed: Feb. 20, 2019

(51) Int. Cl. G06F 9/48; G06F 9/50; G06T 1/20; G06T 1/60

(52) U.S. Cl. CPC G06F 9/4881; G06F 9/5077; G06T 1/60; G06T 1/20; G06F 9/5016

(57) ABSTRACT

Embodiments of the invention may provide a technical solution by having a system for configuring a crypto memory engine. A memory is configured to store instructions for execution by an cryptography application. A graphics processing unit (GPU) is configured to execute the cryptography application, wherein the GPU is configured to identify a set of commonly used algorithms by the cryptography application. The identifying comprises identifying one or more input parameters for the set of commonly used algorithms. The identified set of commonly used algorithms is compiled and stored as a virtual memory module. The virtual memory module with the compiled set of commonly used algorithms is provided to the cryptography application.

### TECHNICAL FIELD

Embodiments of the invention generally relate to providing an enhanced scheduling for vector units.

### BACKGROUND

Vector processing in processors, such as central processing unit (CPU) or graphics processing unit (GPU), implements an instruction set containing instructions that operate on one-dimensional arrays of data called vectors. This is in contrast to scalar processors, whose instructions operate on single data items.

A vector instruction typically performs an operation on each data element in consecutive cycles. The vector functional units in the instruction are pipelined. In addition, each pipeline stage operates on a piece of data, and there are no vector dependencies (internally and between vectors).

However, there are disadvantages, notably if vector operations are irregular. At the same time, memory access may be bottlenecked if memory operation balance is not monitored and maintained and that data is not mapped correctly or appropriately to the proper memory banks.

As for a scalar processing, it typically is classified as a SISD processing (Single Instruction, Single Data). Another variation of this approach is a single instruction, multiple tread (SIMT) processing. Conventional SIMT multithreaded processors provide parallel execution of multiple threads by organizing threads into groups and executing each thread on a separate processing pipeline, scalar or vector pipeline. An instruction for execution by the threads in a group dispatches in a single cycle. The processing pipeline control signals are generated such that all threads in a group perform a similar set of operations as the threads traverse the stages of the processing pipelines. For example, all the threads in a group read source operands from a register file, perform the specified arithmetic operation in processing units, and write results back to the register file. SIMT requires additional memory for replicating the constant values used in the same kernel when multiple contexts are supported in the processor. As such, latency overhead is introduced when different constant values are loaded from main memory or cache.

Cryptography has employed vector processing's advantages in recent years due to vector processing's operational advantages in parallel processing. However, crypto operations, typically based on crypto algorithms and instructions, may be too slow for certain applications. Therefore, embodiments of the invention attempt to solve or address one or more of the technical problems identified above.

### SUMMARY

Embodiments of the invention may provide a technical solution by designing a memory engine for vector processing units or vector processors which may accelerate the performance in name of the computation in crypto applications. For example, embodiments of the invention may create a memory engine that contains a set of most commonly used algorithms, and it includes configurations for applications in advance such that the crypto applications may configure them. In one aspect, each algorithm may be running independently in the memory engine. In a further embodiment, the memory engine interfaces with the application as a memory module such that the initial data is moved to the memory space of the memory engine and then the commands are sent to the engine to start the operation. Furthermore, aspects of the invention configure the memory engine to enable each crypto algorithm therein to start at different clock cycle and each of them may need different number of cycles to finish. In order to achieve this, a compiler and hardware controllers are used to make sure that only one crypto operation finishes/commits at one clock cycle.

### BRIEF DESCRIPTION OF THE DRAWINGS

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is a diagram illustrating a dedicated memory engine according to one embodiment of the invention.

FIG. 2 is a flow chart illustrating a method for creating a dedicated memory engine according to one embodiment of the invention.

FIG. 3 is a block diagram illustrating a computer system configured to implement one or more aspects of the present invention;

FIG. 4 is a block diagram of a parallel processing subsystem for the computer system of FIG. 3, according to one embodiment of the present invention.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

In general, a computational core (see GPC 514 below) utilizes programmable vertex, geometry, and pixel shaders. Rather than implementing the functions of these components as separate, fixed-function shader units with different designs and instruction sets, the operations are instead executed by a pool of execution units with a unified instruction set. Each of these execution units may be identical in design and configurable for programmed operation. In one embodiment, each execution unit may be capable of multi-threaded operation simultaneously. As various shading tasks may be generated by the vertex shader, geometry shader, and pixel shader, they may be delivered to execution units to be carried out.

As individual tasks are generated, an execution control unit (may be part of the GPC 514 below) handles the assigning of those tasks to available threads within the various execution units. As tasks are completed, the execution control unit further manages the release of the relevant threads. In this regard, the Execution control unit is responsible for assigning vertex shader, geometry shader, and pixel shader tasks to threads of the various execution units, and also performs an associated “bookkeeping” of the tasks and threads. Specifically, the execution control unit maintains a resource table (not specifically illustrated) of threads and memories for all execution units. The execution control unit particularly manages which threads have been assigned tasks and are occupied, which threads have been released after thread termination, how many common register file memory registers are occupied, and how much free space is available for each execution unit.

A thread controller may also be provided inside each of the execution units, and may be responsible for scheduling, managing or marking each of the threads as active (e.g., executing) or available.

According to one embodiment, a scalar register file may be connected to the thread controller and/or with a thread task interface. The thread controller provides control functionality for the entire execution unit (e.g., GPC 514), with functionality including the management of each thread and decision-making functionality such as determining how threads are to be executed.

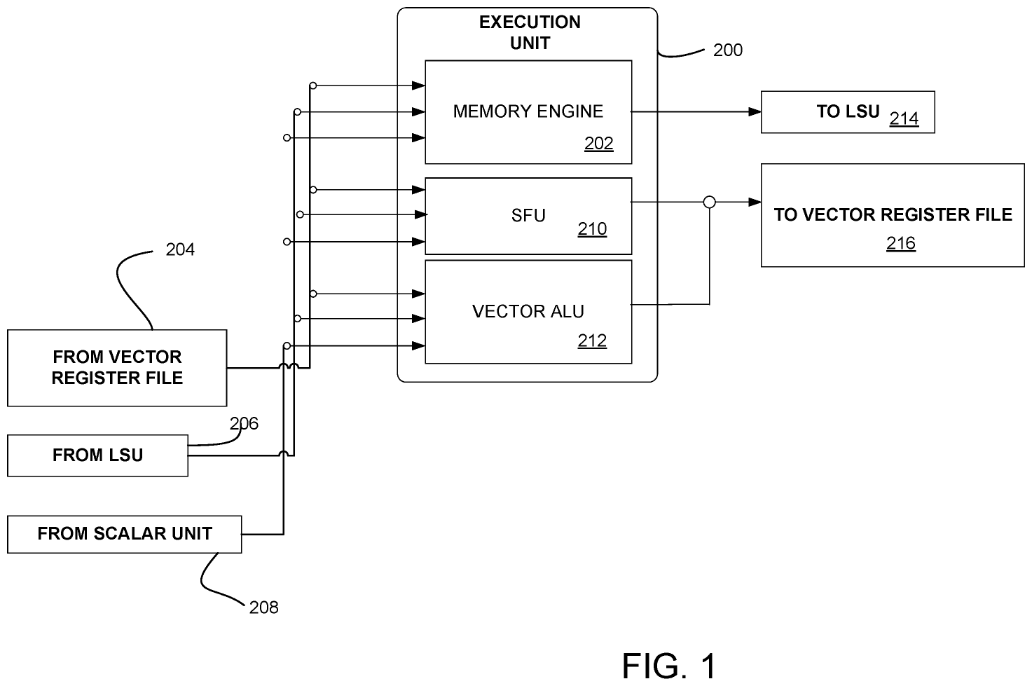

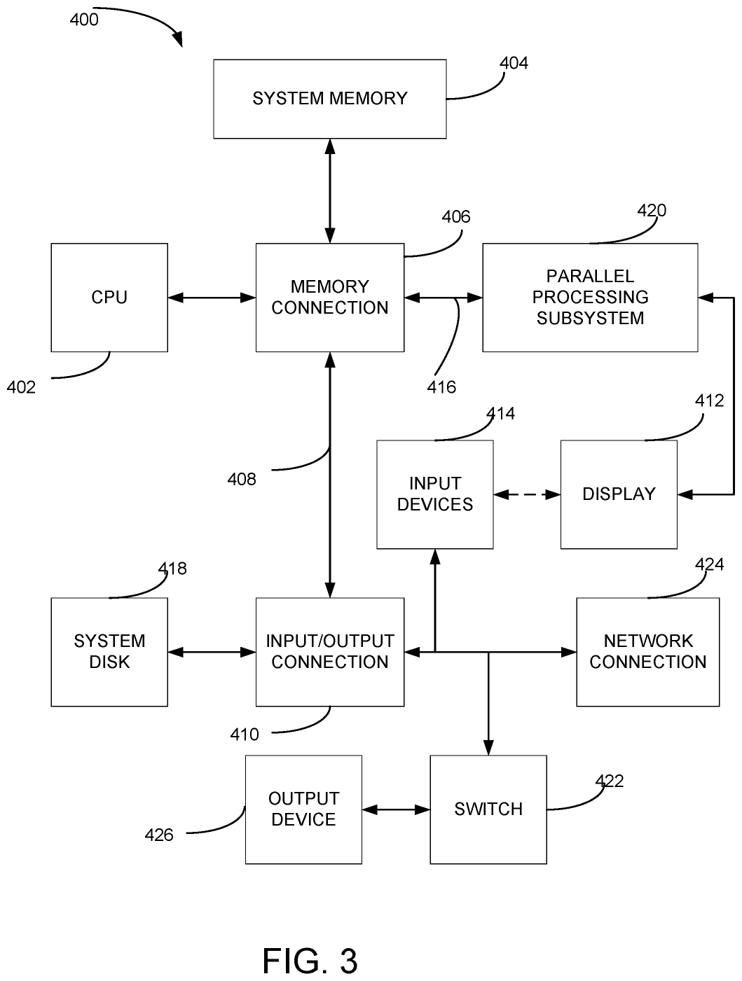

Referring now to FIG. 1, a diagram illustrates a dedicated memory engine 202 in an execution unit 200 according to one embodiment of the invention. For example, the execution unit 200 may be an execution illustrated in FIG. 3. In such an example, the execution unit 200 may be connected or coupled to other hardware such as display, memory units, input and output connections or bridges, other execution units, etc. In one embodiment, commonly used algorithms for cryptography include hashing algorithms, encryption algorithms, etc. In another example, hashing or encryption algorithms include SHA-256, MD5, HMAC, Ethash, Scrypt, Equihash, Cryptonight, X11. DES/3DES or TripleDES, Blowfish, AES, Twofish, IDEA, and RSA Security.

For example, a hash is a function that converts data into a number within a certain range. The hash has the property with its output is essentially unpredictable (within the given range). In one example, a hash function used for cryptocurrency, for example, mining may require execution or application of the SHA-256 twice. As such, in any given hash algorithm, there would be input, or sometimes referred to as message, that represent the data to be hashed, and a size of bit string of a fixed size. Aspects of the invention enable the memory engine 202 to provide the message and the size of bit string as configurable parameters to any given application that calls the hash algorithm.

For example, as shown in FIG. 1, the execution unit 200 may include the memory engine 202 for receiving input from three sources: a vector register file 204, a load-store unit (LSU) 206, and a scalar unit or scalar register file 208. In one example, the vector register file 204 may be organized in four banks of eight (8) 32-bit registers. Each register may store either a single-precision floating-point number or an integer. Any consecutive pair of registers, [R2n+1]:[R2n], may store a double-precision floating-point number. Because a load and store operation does not modify the data, another application that does not use floating-point values may use a vector floating-point process registers as secondary data storage.

In another example, the vector register file 204 may be configured as four circular buffers for use by short vector instructions in applications requiring high data throughput, such as filtering and graphics transforms. For short vector instructions, register addressing is circular in each bank. Because load and store operations do not circulate, it is possible to load or store multiple banks, up to the entire register file, with a single instruction. Short vector operations obey certain rules specifying the conditions under which the registers in the argument list specify circular buffers or single-scalar registers.

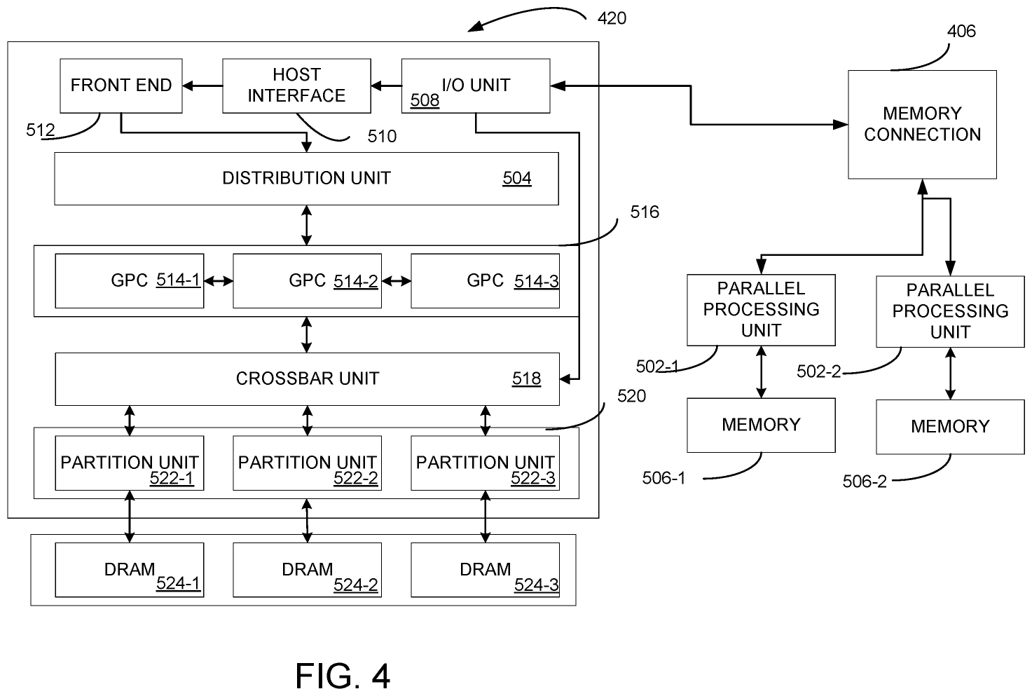

In one embodiment, as the memory engine 202 may be treated as a memory unit for the application (e.g., memory 506 in FIG. 4) and it may accept the LSU 206 as input, the memory engine 202 may receive load and store operations from LSU 206 as a memory module.

For example, the LSU 206 may be a specialized execution unit responsible for executing all load and store instructions, generating virtual addresses of load and store operations, and loading data from memory or storing it back to memory from registers. The LSU usually includes a queue which acts as a waiting area for memory instructions, and the LSU itself operates independently of other processor units. LSUs may also be used in vector processing. Some LSUs are also capable of executing simple fixed-point and/or integer operations.

In a further embodiment, the scalar unit 208 may include scalar values from a scalar register file. For example, the values from the scalar register file may be in response to the data needed for the execution of one or more commonly used algorithms in the memory engine 202.

In one embodiment, the algorithms in the memory engine 202 may be pre-compiled and scheduled by a controller associated with a processor such as the GPU. Such embodiment ensures that no two results of memory engine and vector arithmetic logic unit.

In one example, the memory engine may also be used for other algorithms, such as serialized algorithms. In a simple and exemplary serialized algorithm, it may include the following program structure (in JAVA):

class parent implements Serializable {

int parentVersion = 10;

}
class contain implements Serializable{

int containVersion = 11;

}
public class SerialTest extends parent implements Serializable {

int version = 66;
contain con = new contain( );
public int getVersion( ) {

return version;

}
public static void main(String args[ ]) throws IOException {

FileOutputStream fos = new FileOutputStream(“temp.out”);
ObjectOutputStream oos = new ObjectOutputStream(fos);
SerialTest st = new SerialTest( );
oos.writeObject(st);
oos.flush( );
oos.close( );

}

}

In this example, serialization algorithms may:

write out the metadata of the class associated with an instance;

recursively write out the description of the superclass until it finds java.lang.object;

once it finishes writing the metadata information, it then starts with the actual data associated with the instance. But this time, it starts from the topmost superclass; and

recursively write the data associated with the instance, starting from the least superclass to the most-derived class.

It is to be understood that serialization algorithms written in other programming languages may be exhibit similar characteristics without departing from the scope or spirit of embodiments of the invention.

In another embodiment, the memory engine 202 may provide the stored algorithms to interface with LSU 214 as a virtual memory module to carry out memory storage like capabilities, such as those in memory 506 in FIG. 4. For example, before the execution unit 200 may execute memory engine 202, a scalar function unit (SFU) 210, and a vector arithmetic logical unit (ALU) 212, the execution unit 200 may load and store data needed or required for executing the instructions or algorithms. As the memory engine 202 may store compiled algorithms, the memory engine 202 may be treated as a virtual memory module for specific applications. In that aspect, a specific application may call the algorithms stored in the memory engine 202 by passing parameters needed for the algorithms. As the algorithms in the memory engine 202 have been pre-compiled and ready for execution, the execution unit 200 may execute the specific application faster as the output from executing the algorithms in the memory engine 202 may be loaded to the LSU 214. Similarly, the output of the SFU 210 and vector ALU 212 may be passed to the vector register file 216.

In an exemplary usage of the memory engine 202 may include processing of the cryptography operations where the hashing algorithms may be commonly used or run functions. As the memory engine 202 may store pre-compiled algorithms, the memory engine 202 may faster loading or processing of the cryptography operations. As such, the memory engine 202 may be considered as a crypto engine dedicated to process hashing algorithms.

it is to be understood that the memory engine 202 may be used for processing algorithms, functions, instructions, etc., other than hashing algorithms, serialized algorithms.

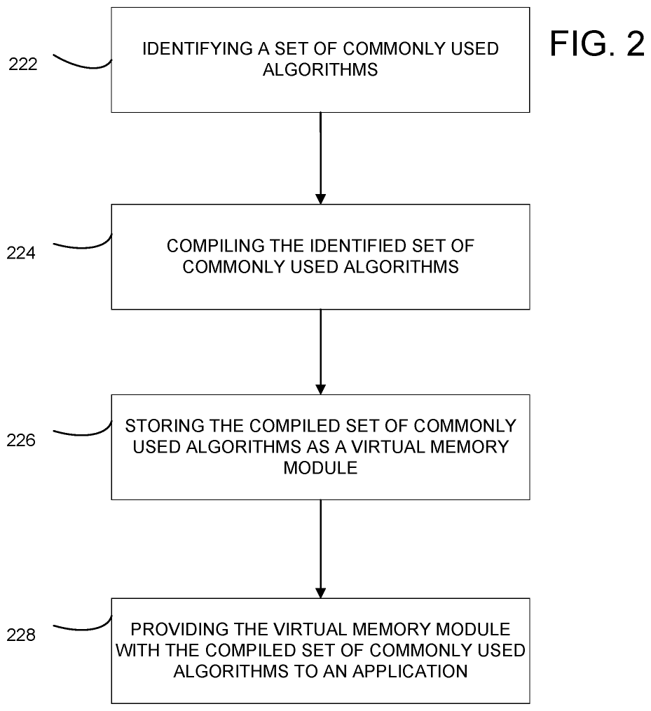

Referring now to FIG. 2, a flow chart illustrates a method for configuring a memory engine or a crypto memory engine according to one embodiment of the invention. At 222, a set of commonly used algorithms is identified. For example, the commonly used algorithms may include hashing algorithms. In one embodiment, identifying comprises identifying one or more input parameters for the set of commonly used algorithms. At 224, the identified set of commonly used algorithms is compiled. At 226, the compiled set of commonly used algorithms is stored as a virtual memory module. For example, the compiled set of commonly used algorithms is stored as a unit instead of at various parts of the memory. At 228, the virtual memory module with the compiled set of commonly used algorithms is provided to an application. In one example, the virtual memory module may be interfaced with the application. In another example, the application may include a cryptography application.

FIG. 3 is a block diagram illustrating a computer system 400 configured to implement one or more aspects of the present invention. Computer system 400 includes a central processing unit (CPU) 402 and a system memory 404 communicating via an interconnection path that may include a memory connection 406. Memory connection 406, which may be, e.g., a Northbridge chip, is connected via a bus or other communication path 408 (e.g., a HyperTransport link) to an I/O (input/output) connection 410. I/O connection 410, which may be, e.g., a Southbridge chip, receives user input from one or more user input devices 414 (e.g., keyboard, mouse) and forwards the input to CPU 402 via path 408 and memory connection 406. A parallel processing subsystem 420 is coupled to memory connection 406 via a bus or other communication path 416 (e.g., a PCI Express, Accelerated Graphics Port, or HyperTransport link); in one embodiment parallel processing subsystem 420 is a graphics subsystem that delivers pixels to a display device 412 (e.g., a CRT, LCD based, LED based, or other technologies). The display device 412 may also be connected to the input devices 414 or the display device 412 may be an input device as well (e.g., touch screen). A system disk 418 is also connected to I/O connection 410. A switch 422 provides connections between I/O connection 410 and other components such as a network adapter 424 and various output devices 426. Other components (not explicitly shown), including USB or other port connections, CD drives, DVD drives, film recording devices, and the like, may also be connected to I/O connection 410. Communication paths interconnecting the various components in FIG. 3 may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

In one embodiment, the parallel processing subsystem 420 incorporates circuitry optimized for graphics and video processing, including, for example, video output circuitry, and constitutes a graphics processing unit (GPU). In another embodiment, the parallel processing subsystem 420 incorporates circuitry optimized for general purpose processing, while preserving the underlying computational architecture, described in greater detail herein. In yet another embodiment, the parallel processing subsystem 420 may be integrated with one or more other system elements, such as the memory connection 406, CPU 402, and I/O connection 410 to form a system on chip (SoC).

It will be appreciated that the system shown herein is illustrative and that variations and modifications are possible. The connection topology, including the number and arrangement of bridges, the number of CPUs 402, and the number of parallel processing subsystems 420, may be modified as desired. For instance, in some embodiments, system memory 404 is connected to CPU 402 directly rather than through a connection, and other devices communicate with system memory 404 via memory connection 406 and CPU 402. In other alternative topologies, parallel processing subsystem 420 is connected to I/O connection 410 or directly to CPU 402, rather than to memory connection 406. In still other embodiments, I/O connection 410 and memory connection 406 might be integrated into a single chip. Large embodiments may include two or more CPUs 402 and two or more parallel processing systems 420. Some components shown herein are optional; for instance, any number of peripheral devices might be supported. In some embodiments, switch 422 may be eliminated, and network adapter 424 and other peripheral devices may connect directly to I/O connection 410.

FIG. 4 illustrates a parallel processing subsystem 420, according to one embodiment of the present invention. As shown, parallel processing subsystem 420 includes one or more parallel processing units (PPUs) 502, each of which is coupled to a local parallel processing (PP) memory 506. In general, a parallel processing subsystem includes a number U of PPUs, where U≥1. (Herein, multiple instances of like objects are denoted with reference numbers identifying the object and parenthetical numbers identifying the instance where needed.) PPUs 502 and parallel processing memories 506 may be implemented using one or more integrated circuit devices, such as programmable processors, application specific integrated circuits (ASICs), or memory devices, or in any other technically feasible fashion.

In some embodiments, some or all of PPUs 502 in parallel processing subsystem 420 are graphics processors with rendering pipelines that can be configured to perform various tasks related to generating pixel data from graphics data supplied by CPU 402 and/or system memory 404 via memory connection 406 and communications path 416, interacting with local parallel processing memory 506 (which can be used as graphics memory including, e.g., a conventional frame buffer) to store and update pixel data, delivering pixel data to display device 412, and the like. In some embodiments, parallel processing subsystem 420 may include one or more PPUs 502 that operate as graphics processors and one or more other PPUs 502 that are used for general-purpose computations. The PPUs may be identical or different, and each PPU may have its own dedicated parallel processing memory device(s) or no dedicated parallel processing memory device(s). One or more PPUs 502 may output data to display device 412 or each PPU 502 may output data to one or more display devices 412.

In operation, CPU 402 is the master processor of computer system 400, controlling and coordinating operations of other system components. In particular, CPU 402 issues commands that control the operation of PPUs 502. In some embodiments, CPU 402 writes a stream of commands for each PPU 502 to a pushbuffer (not explicitly shown in either FIG. 3 or FIG. 4) that may be located in system memory 404, parallel processing memory 506, or another storage location accessible to both CPU 402 and PPU 502. PPU 502 reads the command stream from the pushbuffer and then executes commands asynchronously relative to the operation of CPU 402.

Referring back now to FIG. 4, each PPU 502 includes an I/O (input/output) unit 508 that communicates with the rest of computer system 400 via communication path 416, which connects to memory connection 406 (or, in one alternative embodiment, directly to CPU 402). The connection of PPU 502 to the rest of computer system 400 may also be varied. In some embodiments, parallel processing subsystem 420 is implemented as an add-in card that can be inserted into an expansion slot of computer system 400. In other embodiments, a PPU 502 can be integrated on a single chip with a bus connection, such as memory connection 406 or I/O connection 410. In still other embodiments, some or all elements of PPU 502 may be integrated on a single chip with CPU 402.

In one embodiment, communication path 416 is a PCI-EXPRESS link, in which dedicated lanes are allocated to each PPU 502, as is known in the art. Other communication paths may also be used. An I/O unit 508 generates packets (or other signals) for transmission on communication path 416 and also receives all incoming packets (or other signals) from communication path 416, directing the incoming packets to appropriate components of PPU 502. For example, commands related to processing tasks may be directed to a host interface 510, while commands related to memory operations (e.g., reading from or writing to parallel processing memory 506) may be directed to a memory crossbar unit 518. Host interface 510 reads each pushbuffer and outputs the work specified by the pushbuffer to a front end 512.

Each PPU 502 advantageously implements a highly parallel processing architecture. As shown in detail, PPU 502(0) includes a processing cluster array 516 that includes a number C of general processing clusters (GPCs) 514, where

Each GPC 514 is capable of executing a large number (e.g., hundreds or thousands) of threads concurrently, where each thread is an instance of a program. In various applications, different GPCs 514 may be allocated for processing different types of programs or for performing different types of computations. For example, in a graphics application, a first set of GPCs 514 may be allocated to perform patch tessellation operations and to produce primitive topologies for patches, and a second set of GPCs 514 may be allocated to perform tessellation shading to evaluate patch parameters for the primitive topologies and to determine vertex positions and other per-vertex attributes. The allocation of GPCs 514 may vary dependent on the workload arising for each type of program or computation.

GPCs 514 receive processing tasks to be executed via a work distribution unit 504, which receives commands defining processing tasks from front end unit 512. Processing tasks include indices of data to be processed, e.g., surface (patch) data, primitive data, vertex data, and/or pixel data, as well as state parameters and commands defining how the data is to be processed (e.g., what program is to be executed). Work distribution unit 504 may be configured to fetch the indices corresponding to the tasks, or work distribution unit 504 may receive the indices from front end 512. Front end 512 ensures that GPCs 514 are configured to a valid state before the processing specified by the pushbuffers is initiated.

When PPU 502 is used for graphics processing, for example, the processing workload for each patch is divided into approximately equal sized tasks to enable distribution of the tessellation processing to multiple GPCs 514. A work distribution unit 504 may be configured to produce tasks at a frequency capable of providing tasks to multiple GPCs 514 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 514 are configured to perform different types of processing. For example a first portion may be configured to perform vertex shading and topology generation, a second portion may be configured to perform tessellation and geometry shading, and a third portion may be configured to perform pixel shading in pixel space to produce a rendered image. Intermediate data produced by GPCs 514 may be stored in buffers to allow the intermediate data to be transmitted between GPCs 514 for further processing.

Memory interface 520 includes a number D of partition units 522 that are each directly coupled to a portion of parallel processing memory 506, where D≥1. As shown, the number of partition units 522 generally equals the number of DRAM 524. In other embodiments, the number of partition units 522 may not equal the number of memory devices. Persons skilled in the art will appreciate that DRAM 524 may be replaced with other suitable storage devices and can be of generally conventional design. A detailed description is therefore omitted. Render targets, such as 522-1 frame buffers or texture maps may be stored across DRAMs 524, allowing partition units 522 to write portions of each render target in parallel to efficiently use the available bandwidth of parallel processing memory 506.

Any one of GPCs 514 may process data to be written to any of the DRAMs 524 within parallel processing memory 506. Crossbar unit 518 is configured to route the output of each GPC 514 to the input of any partition unit 522 or to another GPC 514 for further processing. GPCs 514 communicate with memory interface 520 through crossbar unit 518 to read from or write to various external memory devices. In one embodiment, crossbar unit 518 has a connection to memory interface 520 to communicate with I/O unit 508, as well as a connection to local parallel processing memory 506, thereby enabling the processing cores within the different GPCs 514 to communicate with system memory 404 or other memory that is not local to PPU 502. In the embodiment shown in FIG. 4, crossbar unit 518 is directly connected with I/O unit 508. Crossbar unit 518 may use virtual channels to separate traffic streams between the GPCs 514 and partition units 522.

Again, GPCs 514 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 502 may transfer data from system memory 404 and/or local parallel processing memories 506 into internal (on-chip) memory, process the data, and write result data back to system memory 404 and/or local parallel processing memories 506, where such data can be accessed by other system components, including CPU 402 or another parallel processing subsystem 420.

A PPU 502 may be provided with any amount of local parallel processing memory 506, including no local memory, and may use local memory and system memory in any combination. For instance, a PPU 502 can be a graphics processor in a unified memory architecture (UMA) embodiment. In such embodiments, little or no dedicated graphics (parallel processing) memory would be provided, and PPU 502 would use system memory exclusively or almost exclusively. In UMA embodiments, a PPU 502 may be integrated into a bridge chip or processor chip or provided as a discrete chip with a high-speed link (e.g., PCI-EXPRESS) connecting the PPU 502 to system memory via a bridge chip or other communication means.

As noted above, any number of PPUs 502 can be included in a parallel processing subsystem 420. For instance, multiple PPUs 502 can be provided on a single add-in card, or multiple add-in cards can be connected to communication path 416, or one or more of PPUs 502 can be integrated into a bridge chip. PPUs 502 in a multi-PPU system may be identical to or different from one another. For instance, different PPUs 502 might have different numbers of processing cores, different amounts of local parallel processing memory, and so on. Where multiple PPUs 502 are present, those PPUs may be operated in parallel to process data at a higher throughput than is possible with a single PPU 502. Systems incorporating one or more PPUs 502 may be implemented in a variety of configurations and form factors, including desktop, laptop, or handheld personal computers, servers, workstations, game consoles, embedded systems, and the like.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

Apparently, the aforementioned embodiments are merely examples illustrated for clearly describing the present application, rather than limiting the implementation ways thereof. For a person skilled in the art, various changes and modifications in other different forms may be made on the basis of the aforementioned description. It is unnecessary and impossible to exhaustively list all the implementation ways herein. However, any obvious changes or modifications derived from the aforementioned description are intended to be embraced within the protection scope of the present application.

The example embodiments may also provide at least one technical solution to a technical challenge. The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications, or modification of the disclosure.

In summary, the integrated circuit with a plurality of transistors, each of which may have a gate dielectric with properties independent of the gate dielectric for adjacent transistors provides for the ability to fabricate more complex circuits on a semiconductor substrate. The methods of fabricating such an integrated circuit structures further enhance the flexibility of integrated circuit design. Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A computer-implemented method for configuring a memory engine comprising:
identifying a set of commonly used algorithms, wherein the set of commonly used algorithms comprises a serialization algorithm, wherein identifying comprising identifying one or more input parameters for the set of commonly used algorithms;
compiling the identified set of commonly used algorithms;
storing the compiled set of commonly used algorithms as a virtual memory module; and
providing the virtual memory module with the compiled set of commonly used algorithms to an application, said application comprising a controller associated with a graphics processing unit (GPU).

2. The computer-implemented method of claim 1, wherein identifying the one or more input parameters comprising receiving data from a vector register file.

3. The computer-implemented method of claim 1, wherein identifying the one or more input parameters comprising receiving data from a load-store unit.

4. The computer-implemented method of claim 1, wherein identifying the one or more input parameters comprising receiving data from a scalar unit.

5. The computer-implemented method of claim 1, further comprising providing a first output of the virtual memory module to another load-store unit.

6. The computer-implemented method of claim 1, wherein providing the virtual memory module to a cryptography application along with a scalar function unit and a vector arithmetic logical unit (ALU).

7. A graphics processing subsystem for configuring a memory engine comprising:
a graphics processing unit (GPU) operable to:
identifying a set of commonly used algorithms, wherein the set of commonly used algorithms comprises a serialization algorithm, wherein identifying comprising identifying one or more input parameters for the set of commonly used algorithms;
compiling the identified set of commonly used algorithms;
storing the compiled set of commonly used algorithms as a virtual memory module; and
providing the virtual memory module with the compiled set of commonly used algorithms to an application, said application comprising a controller associated with the GPU.

8. The graphics processing subsystem of claim 7, wherein identifying the one or more input parameters comprising receiving data from a vector register file.

9. The graphics processing subsystem of claim 7, wherein identifying the one or more input parameters comprising receiving data from a load-store unit.

10. The graphics processing subsystem of claim 7, wherein identifying the one or more input parameters comprising receiving data from a scalar unit.

11. The graphics processing subsystem of claim 7, further comprising providing a first output of the virtual memory module to another load-store unit.

12. The graphics processing subsystem of claim 7, wherein providing the virtual memory module to a cryptography application along with a scalar function unit and a vector arithmetic logical unit (ALU).

13. A system for configuring a crypto memory engine comprising:
a memory configured to store instructions for execution by an cryptography application;
a graphics processing unit (GPU) configured to execute the cryptography application, wherein the GPU is configured to:
identifying a set of commonly used algorithms by the cryptography application, wherein the set of commonly used algorithms comprises a serialization algorithm, wherein identifying comprising identifying one or more input parameters for the set of commonly used algorithms;
compiling the identified set of commonly used algorithms;
storing the compiled set of commonly used algorithms as a virtual memory module; and
providing the virtual memory module with the compiled set of commonly used algorithms to the cryptography application.

14. The system of claim 13, wherein identifying the one or more input parameters comprising receiving data from a vector register file.

15. The system of claim 13, wherein identifying the one or more input parameters comprising receiving data from a load-store unit.

16. The system of claim 13, wherein identifying the one or more input parameters comprising receiving data from a scalar unit.

17. The system of claim 13, further comprising providing a first output of the virtual memory module to another load-store unit.

18. The system of claim 13, wherein providing the virtual memory module to the cryptography application along with a scalar function unit and a vector arithmetic logical unit (ALU).

19. The system of claim 13, wherein the set of commonly used algorithms comprises hashing algorithms.
